(19) United States
(12) Patent Application Publication
(10) Pub. No.: US 2016/0330930 A1
(43) Pub. Date: Nov. 17, 2016

(54) Waterline and Feedline Paper for a Poultry House

(71) Applicant: Jackson Paper Manufacturing Company, Sylva, NC (US)

(72) Inventors: Timothy L. Campbell, Sylva, NC (US); Charles Shane Ramsey, Sylva, NC (US)

(73) Assignee: Jackson Paper Manufacturing Company, Sylva, NC (US)

(21) Appl. No.: 15/154,540

(22) Filed: May 13, 2016

Related U.S. Application Data
(60) Provisional application No. 62/160,744, filed on May 13, 2015.

(51) Int. Cl. A01K 1/015

(52) U.S. Cl. CPC A01K 1/0155; A01K 1/0157

(57) ABSTRACT

A waterline and feedline paper for use in a poultry house including a substrate having a first side and an opposing second side, the substrate being formed from a cellulose product; the substrate being sized and configured to be laid under one or more elongated waterlines or feedlines in the poultry house; the substrate having a strength that is at least fifty pounds per square inch; the substrate having a ring crush that is at least twenty-one pounds per square inch; the substrate having a porosity of approximately twenty seconds, wherein the porosity is a measurement of the amount of time for a particular volume of air to pass through the substrate; the substrate having a moisture content between six and nine percent water; the substrate having a thickness of approximately 0.08 inches, thereby enhancing the rustling sound when chicks are walking on the substrate and attracting more chicks to the substrate; the substrate including a visual attraction element; and the substrate being structured and disposed for absorbing chick droppings for preventing the chicks from pecking at their droppings.

This application is based on and claims priority to provisional patent application No. 62/160,744 filed on May 13, 2015.

### BACKGROUND OF THE INVENTION

1. Field of the Invention

This invention relates to the use of waterline and feedline paper in a poultry feeding house. More particularly, it relates to the use of paper on the floor of a poultry house immediately below a waterline and/or feedline for attracting chicks to the waterline and/or feedline.

2. Discussion of the Related Art

When baby chicks are introduced into a poultry house, it is critical that they begin drinking water promptly, otherwise they will quickly die from dehydration. Poultry houses include elongated waterlines parallel to one another. These waterlines have individual spaced apart drinking stations set at a level above the ground which is low enough for small chicks to drink from. With hundreds of baby chicks on the floor of the poultry house, it can become problematic for some of the chicks to find the drinking stations. This can result in a high mortality rate for the chicks. Moreover, it is also important that the chicks be attracted to feedlines.

The poultry industry has utilized elongated strips of paper, sometimes referred to as chick paper, under these waterlines. The idea behind the chick paper is to provide rustling sounds, caused by the feet of some of the chicks on the paper, which will attract other chicks to the drinking area. While this type of chick paper has shown some promise, there are advancements which can be made.

Therefore, with the foregoing reasons in mind, there exists a need in the art for an improved chick paper which helps ensure survival of a large number of the chicks during the early part of their lives.

### SUMMARY OF THE INVENTION

The present invention is directed to a waterline and feedline paper for use in a poultry house, the waterline and feedline paper including a substrate having a first side and an opposing second side, the substrate being formed from a cellulose product; the substrate being sized and configured to be laid under one or more elongated waterlines or feedlines in the poultry house; the substrate having a strength that is at least fifty pounds per square inch; the substrate having a ring crush that is at least twenty-one pounds per square inch; the substrate having a porosity of approximately twenty seconds, wherein the porosity is a measurement of the amount of time for a particular volume of air to pass through the substrate; the substrate having a moisture content between six and nine percent water; the substrate having a thickness of approximately 0.08 inches, thereby enhancing the rustling sound when chicks are walking on the substrate and attracting more chicks to the substrate; the substrate including a visual attraction element; and the substrate being structured and disposed for absorbing chick droppings for preventing the chicks from pecking at their droppings.

### BRIEF DESCRIPTION OF THE DRAWINGS

For a fuller understanding of the nature of the present invention, reference should be made to the following detailed description, taken in conjunction with the accompanying drawings in which:

FIG. 1 is a perspective view of the waterline and feedline paper substrate of the present invention according to one embodiment.

Like reference numerals refer to like reference parts throughout the several views of the drawings.

### DESCRIPTION OF THE PREFERRED EMBODIMENTS OF THE INVENTION

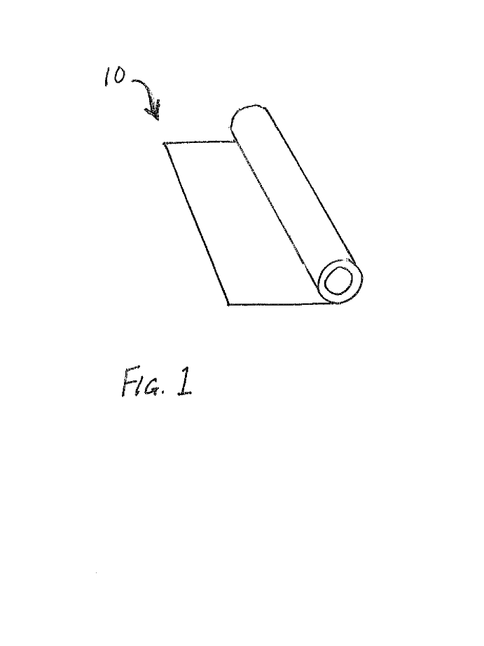

Referring to FIG. 1, the present invention includes a roll of elongated paper substrate 10 made of one hundred percent recycled cellulose product which preferably conforms to all SFI (certificate 5GS-SFI/COC-US09/74/90) and FSC (certificate SGSNA-d06433,5GS-COC-006433). Preferably, the paper substrate is twelve inches to forty-eight inches wide. The paper substrate is unrolled and laid under elongated waterlines in a poultry house. The waterlines have spaced apart drinking stations. The same paper may also be laid under feedlines. The physical characteristics of the paper enable the paper to emit a substantial rustling sound when walked on by some of the chicks to attract other chicks to the drinking or feeding station.

Grade twenty-three and grade twenty-six are the preferred grades of paper primarily because of ease of installation. Preferably, the basis weight of the grade twenty-three paper should be between twenty-five and twenty-one pounds per one thousand square feet with the more preferred basis weight being twenty-three pounds per one thousand square feet. Where grade twenty-six paper is used, preferably the basis weight range is between twenty-eight and twenty-four and a half pounds per one thousand square feet with the more preferred basis weight being twenty-six pounds per one thousand square feet.

Preferably, the strength of the paper substrate, sometimes referred to as Concora, for the grade twenty-three paper is greater than forty-eight pounds per square inch with a more preferred strength of fifty-two pounds per square inch. For the grade twenty-six grade paper, the preferred strength is greater than fifty pounds per square inch with a more preferred strength of fifty-five pounds per square inch.

The ring crush for the twenty-three basis weight paper, is preferably greater than twenty-one pounds per square inch with a more preferred ring crush of twenty-five pounds per square inch. For twenty-six grade paper, the ring crush is preferably greater than twenty-five pounds per square inch with a more preferred ring crush being thirty-three pounds per square inch.

For both the twenty-three and the twenty-six grade paper, the time for a drop of water to pass through the paper is preferably targeted at three seconds.

The porosity of the paper substrate as measured in terms of the amount of time for a certain volume of air to pass through the paper is preferably twenty seconds for both the twenty-three and the twenty-six grade paper. The moisture content of both the twenty-three and the twenty-six grade paper is preferably between six and nine percent water and more preferably seven percent water. In one embodiment, the paper may be perforated by 100 micron holes at a rate of 100 per square inch for allowing for moisture evaporation and airflow there through.

Preferably, the thickness of the paper substrate is approximately 0.08 inches, thereby enhancing the rustling sound when chicks are walking on the paper. Moreover, the 100 micron hole perforations at a rate of 100 per square inch, as described above, provide a texture element for the chicks to walk on.

Paper substrate prepared in accordance with the above criteria will emit substantial rustling sounds when some of the chicks walk on the paper under the waterlines so as to attract more chicks to the paper so that the chicks will be near the drinking stations and have an opportunity to drink water and thus survive. The same is true for using the paper under feedlines.

In addition to the characteristics set forth above, it is preferred that the paper substrate have a visual attraction for the chicks. It is preferred that the paper be dyed bright red or green using food grade dyes. It is preferred that the red colors be pantone reds between PMS 1806 and PMS 484. In one embodiment, the red colors are pantone reds between PMS 484 and PMS 485. It is preferred that the green colors be pantone green between the pantone colors PMS 7497 and PMS 7499. In one embodiment, the green colors are pantone greens between the pantone colors PMS 360 and PMS 370. These bright colors provide a visual attraction to the waterline or feedline for the chicks in addition to the audible attraction discussed above so as to further enhance the survival probability for the chicks.

The paper substrate described above is sufficiently strong so that the chicks and workers walking on the paper do not readily damage the paper. The water absorption characteristic of the paper is such so as to prevent the paper from readily becoming soggy so as to fall apart. In addition, the paper described above is comfortable for the chicks and provides a cushioning and shock absorbing effect to encourage the chicks to walk on the paper. Also, the paper provides insulation for the floor so that the chicks are warmer. In addition, the paper described above is biodegradable so that its disposal after use will not negatively impact the environment. Since the paper absorbs chick droppings, environmental hygiene is improved and prevents the chicks from pecking at their droppings.

Measurements of surface roughness, color/brightness, and friction of the paper substrate have been made in accordance with the protocol stated below. The results of such measurements are also set forth below.

The roughness of paper substrate although sometimes apparent to the touch, is actually an ambiguous physical property due to the compressibility of an ill-defined fractal fiber surface. Accordingly, in the paper industry an apparent roughness is measured by several methods based on air flow along the surface in a constrained concentric circular geometry. This method provides a numeric value that is proportional to an integral of the apparent surface void volume. An alternative method adopted for very rough paper surfaces has been the stylus profilometer technique. In this measurement, the stylus traverses about 5 inches of length of paper in one direction and the fine scale relative displacement of a stylus in contact with the surface is recorded at 0.01 inch intervals for a total of 500 readings. Values “Microaverage” and “MicroDev” are output by the instrument in relative units, higher values corresponding to rougher paper topographies. MD measurements are smaller than CD values for the same paper surface. Linerboard printability has been found to be good for MicroAverage values 0.3000 and lower or Microdeviations 140 and lower. Brightness is the reflectivity of paper at 427 nm (blue light) exposed to a broad white light spectrum. This measurement is sensitive to the amount of bleaching and optical brightener content. Color of a sheet is measured by a spectrophotometer which describes the hue in terms of color coordinates L, a, b (HunterLab) or CIE L*,a*,b*, which incorporate the sensitivity response of the human eye to color. The method to measure friction was developed through research at FPL Madison Wis. by Gunderson and has resulted in the commercialized instrument dubbed the Amontons II which follows the ISO documented method 15359.

Standard Tappi methods are used in most tests unless otherwise specified.

Measurements consist of 6 or more repeats per sample.

Stylus roughness—an Emveco 210 R style profilometer was used with version 1.1.3 software, keeping the direction of travel of the instrument consistent in either MD or CD. Both sides of each sheet (Top) is take as the labelled side, Bottom as the flip side) were tested in 5 separate tracks. Standard settings of 0.01″ intervals between stylus readings and 500 data points per measurement were used.

Friction—an Amontons II instrument by Mu Measurements was used. Samples were cut in the MD and measured front (labeled side) sliding against back (inside). Three passes were made per sample and the value recorded was the 3^{rd} pass static and kinetic friction coefficients as per method ISO 15359. 5 repeat runs.

Brightness, CIE Color—a Technidyne Tappi spectrophotometer was used to measure brightness (reflectivity at 457 nm) and the CIE L* being lightness, a* being redness and b* being yellowness. A high L* value corresponds to how bright the sheet is, a high a* value corresponds to red, high b* corresponds to yellow. A combined high positive a* and b* leads to an orange or beige color. A combined high negative a* and b* values lead to a teal shade. 5 repeats were made per sample.

Data—Most measurements consist of at least 6 repeats or more whenever possible. A comparison of significant differences between samples can be gleaned through comparison of the results with error bars representing the 95% confidence intervals (“c.i” in the Tables) of the results from repeated measurement for each sample.

TABLE 1
Summary of test results: MicroAverage and MicroDeviation
are different calculations for the stylus data produced
by the instrument. “c.i.” are 95% confidence intervals
for each average value. Typically, CD values in roughness
are larger than in the MD since the stylus rides across
the fibers in the CD and so registers a larger roughness.
Emveco Profilometer Surface Stylus

| | | |
|---|---|---|
| Top Side MD | 306.55 | 20.92 |
| MicroDeviation | | |
| Top Side MD | 0.4172 | 0.0243 |
| MicroAverage | | |
| Top Side CD | 610.35 | 61.56 |
| MicroAverage | | |
| Top Side CD | 0.6067 | 0.0283 |
| MicroDeviation | | |
| Bottom Side MD | 250.64 | 39.71 |
| Microdeviation | | |
| Bottom Side MD | 0.3811 | 0.0414 |
| MicroAverage | | |
| Bottom Side CD | 403.07 | 46.84 |
| MicroDeviation | | |
| Bottom Side CD | 0.4969 | 0.0299 |
| MicroAverage | | |

TABLE 2
Spectrophotometer results.
Brightness Color

| | Top | Bottom |
|---|---|---|
| Brightness | 15.71 | 16.71 |
| L* | 57.73 | 59.91 |
| a* | 4.13 | 4.15 |
| b* | 19.63 | 19.89 |
| Whiteness CIE | −108.57 | −106.12 |
| Whiteness ASTM | −14.94 | −15.6 |

TABLE 3
Results from the Amontons II Friction Test
Friction ISO Method

| First Pass | | | | Third Pass | | | |
|---|---|---|---|---|---|---|---|
| Static | c.i. | Kinetic | c.i. | Static | c.i. | Kinetic | c.i. |
| 0.35 | 0.011 | 0.227 | 0.004 | 0.238 | 0.008 | 0.194 | 0.002 |

From the foregoing description of one embodiment of the invention, it will be apparent that many modifications may be made therein. It will be understood that this embodiment of the invention is an exemplification of the invention only and that the invention is not limited thereto.

What is claimed is:

1. A waterline and feedline paper for use in a poultry house, said waterline and feedline paper comprising:
a substrate having a first side and an opposing second side, said substrate being formed from a cellulose product;
said substrate being sized and configured to be laid under one or more elongated waterlines or feedlines in the poultry house;
said substrate having a strength that is at least fifty pounds per square inch;
said substrate having a ring crush that is at least twenty-one pounds per square inch;
said substrate having a porosity of approximately twenty seconds, wherein the porosity is a measurement of the amount of time for a particular volume of air to pass through said substrate;
said substrate having a moisture content between six and nine percent water;
said substrate having a thickness of approximately 0.08 inches, thereby enhancing the rustling sound when chicks are walking on said substrate and attracting more chicks to said substrate;
said substrate including a visual attraction element; and
said substrate being structured and disposed for absorbing chick droppings for preventing the chicks from pecking at their droppings.

2. The waterline and feedline paper as recited in claim 1 wherein said substrate is twelve inches to forty-eight inches wide.

3. The waterline and feedline paper as recited in claim 1 wherein the basis weight of said substrate is between twenty-one and twenty-five pounds per one thousand square feet.

4. The waterline and feedline paper as recited in claim 1 wherein the basis weight of said substrate is between twenty-four and a half and twenty-eight pounds per one thousand square feet.

5. The waterline and feedline paper as recited in claim 1 wherein said substrate is perforated by 100 micron holes at a rate of 100 per square inch for allowing for moisture evaporation and airflow there through.

6. The waterline and feedline paper as recited in claim 1 wherein said visual attraction element includes pantone reds between PMS 484 and PMS 485.

7. The waterline and feedline paper as recited in claim 1 wherein said visual attraction element includes pantone greens between PMS 360 and PMS 370.
